(19) United States
(12) Patent Application Publication
(10) Pub. No.: US 2009/0307400 A1
(43) Pub. Date: Dec. 10, 2009

(54) Method for Operating a Lin Bus

(76) Inventors: Ralf Machauer, Marbach (DE); Ingo Mauel, Bietigheim-Bissingen (DE)

Correspondence Address: KENYON & KENYON LLP, ONE BROADWAY, NEW YORK, NY, 10004, US

(21) Appl. No.: 12/227,816

(22) PCT Filed: Jul. 3, 2007
(86) PCT No.: PCT/EP2007/056687

§ 371 Date: May 4, 2009

(30) Foreign Application Priority Data
Jul. 12, 2006 (DE) 102006032217.7

(51) Int. Cl. G06F 13/14; G06F 13/00

(52) U.S. Cl. 710/110; 710/305

(57) ABSTRACT

A method for operating a LIN bus, whose specifications in normal operation are described by a LIN bus in which an alternative communications protocol is tunneled through the LIN protocol, for carrying out a special operation.

### FIELD OF THE INVENTION

The present invention relates to a method for operating a LIN bus, a system having a LIN bus, a computer program and a computer program product.

### BACKGROUND INFORMATION

A LIN bus or a LIN network is a so-called field bus which is interconnected with the electronic components, such as actuators and sensors, predominantly in motor vehicle construction. The abbreviation LIN stands for local interconnect network. Electronic components are connected to one another, via LIN buses, which are predominantly accommodated in devices that are not directly used for the locomotion of the motor vehicle and are accommodated, for instance, in seats or doors. It is provided that one component, and thus one user is developed as superordinate LIN master. The additional components or users are provided as LIN slaves. A LIN slave usually only transmits data over the LIN bus when it has been called upon by a request to do so.

LIN buses are developed to be less complex that CAN (controller area network) buses. Since they have a lower bandwidth, however, a lower data transmission rate is possible than in CAN buses. It should be noted, however, that LIN buses are more cost effective than LAN buses.

### SUMMARY

The present invention relates to a method for operating a LIN bus, whose specifications in normal operation are described by a LIN bus in which an alternative communications protocol is tunneled through the LIN protocol, for carrying out a special operation.

Because of such a tunneling of the communications protocol through the LIN protocol, functional properties of the LIN bus, or of at least one user of the LIN bus, are modified. Consequently, it is possible that the at least one user carries out technical functions during the special operation and/or reacts to technical interactions which differ from functions and interactions of the normal operation.

To carry out the method, it is provided in a refinement that a service connected with the communications protocol will be imaged onto a frame of the LIN protocol. Consequently, a LIN frame is used to transmit another communications protocol in it. For this, at least one datum of the frame is reserved as a function of the service. Parameters of the alternative communications protocol are furthermore to be reserved as a function of the service.

During the special operation, at least one user of the LIN bus is able to be programmed via the communications protocol. Alternatively, or in company with it, a diagnosis may also be carried out during the special operation, the alternative communications protocol being imaged onto a frame developed as a diagnostic frame of the LIN protocol.

It is possible to tunnel different alternative communications protocols through the LIN protocol, and to image appropriate services onto the frame of the LIN protocol, in this context. When tunneling through a UDS protocol through the LIN protocol, a UDS service is imaged onto the frame. When tunneling through a proprietary protocol through the LIN protocol, a proprietary service is imaged onto the frame. When tunneling through a KWP2000 protocol through the LIN protocol, a KWP2000 service is imaged onto the frame.

In addition, the present invention relates to an system having a LIN bus having a plurality of users. Specifications of the LIN bus are described by a LIN protocol in normal operation. For carrying out a special operation, the system is developed for tunneling an alternative communications protocol through the LIN protocol.

In the system, a first user is typically developed as master, and at least one second user is developed as slave. In this case, it is provided, for carrying out a communication and a data exchange connected with it, that the master transmits queries to the slave and the slave transmits responses to the master.

The system or at least a user of the system is developed for carrying out all the steps of the method according to the present invention.

A computer program according to an example embodiment of the present invention, having program code, is provided to implement all steps of a method according to the present invention, when the computer program is executed on a computer or a corresponding computing unit, especially in a system according to the present invention.

The present invention also relates to a computer program product having program code, that are stored on a computer-readable storage medium, in order to execute all the steps of the method according to the present invention if the computer program is executed on a computer or a corresponding central processing unit, in particular a control unit in a system according to the present invention.

Using the present invention, it is possible to use diagnostic frames of the LIN protocol for transmitting in them other communications protocols and particularly diagnostic protocols. In a refinement, this takes place by the UDS protocol as well as the proprietary protocol. The example embodiment of the present invention broadens the application of diagnostic protocols, such as Unified Diagnostic Services (UDS), proprietary services or KWP2000, for the LIN bus system, especially for a Revision 2.0 and for older revisions, so that tunneling of these diagnostic protocols through the LIN bus protocol is possible.

Consequently, using the example embodiment of the present invention, a method can be carried out for implementing a diagnostic mechanism for a LIN node, a slave, as a rule. The method especially builds on a concept for the LIN diagnosis and a configuration specification according to Revision 2.0. Alternative procedures for collecting diagnostic data are implemented thereby. The concept takes into account the development of a “user-defined diagnostic” and a “diagnostic transport layer”. The diagnostic concept should be understood as a broadening of, or addition to a standard communications protocol, and thus to the LIN protocol of the LIN bus. As requirements for this protocol it is provided that an electronic control unit (ECU) uses a diagnostic concept which implements at least one of communications protocols LIN 1.2, LIN 1.3, LIN 2.0, SAE J2602 (published in August 2004).

A data transmission rate in the communications protocol is defined by a respective project. If this project requires utilization of different data transmission rates for normal application and a diagnostic operation, utilization of a mechanism for changing the data transmission rates is possible.

Diagnostic messages are usually transmitted within the LIN instruction frame that is reserved for requests of the master and responses of the slave as participators in the LIN bus, and examples for this are shown in Table 1.

TABLE 1
Diagnostic Identifier

| Identifier (Hex) | Description |
|---|---|
| 0x3c | Request frame of the master |
| 0x3d | Response frame of the slave |

For a summary of diagnostic data, both for the requests of the master and for the responses of the slave, the frame types are provided that are shown in exemplary fashion in the following Table 2:

TABLE 2
Frame type for requests of the master and responses
of the slave.

| Type | Description |
|---|---|
| Single frame (SF) | The SF is used if the |
| | transmitted diagnostic message |
| | fits into a single LIN |
| | diagnostic frame. |
| First frame (FF) | The FF is used if the |
| | transmitted diagnostic message |
| | is longer than a single LIN |
| | frame. The first LIN frame of |
| | the diagnostic message has the |
| | structure of the SF, in this |
| | context. |
| Continuation frame CF | The FF is used if the |
| | transmitted diagnostic message |
| | is longer than a LIN frame. |
| | All LIN frames except for FF |
| | have the structure of TF. |

Diagnostic frames typically include 8 data bytes. A possible structure of possible diagnostic frames is shown in the following Table 3.

TABLE 3
Structure of diagnostic frames

| | | | Data bytes | | | | | | | |
|---|---|---|---|---|---|---|---|---|---|---|
| Transmitter | Type | ID | Byte 1 | Byte 2 | Byte 3 | Byte 4 | Byte 5 | Byte 6 | Byte 7 | Byte 8 |
| Master | SF | 0x3c | NAD | PCI | SID | D1 | D2 | D3 | D4 | D5 |
| Master | FF | 0x3c | NAD | PCI | LEN | ID | D1 | D2 | D3 | D4 |
| Master | CF | 0x3c | NAD | PCI | D1 | D2 | D3 | D4 | D5 | D6 |
| Slave | SF | 0x3d | NAD | PCI | RSID | D1 | D2 | D3 | D4 | D5 |
| Slave | FF | 0x3d | NAD | PCI | LEN | RSID | D1 | D2 | D3 | D4 |
| Slave | CF | 0x3d | NAD | PCI | D1 | D2 | D3 | D4 | D5 | D6 |

The abbreviation NAD stands for node address, in this instance. This was specified for the first time in the diagnostic and configuration specification of LIN according to Version 2.0. NAD designates the address of the slave node that is addressed via the request. NAD may also be used to indicate the source of a request. The following Table 4 shows an example of the utilization of the node address (NAD) at certain system configurations.

TABLE 4
Overview for the definition of NAD

| Communications | Topology of the | |
|---|---|---|
| protocol | system | Node address (NAD) |
| LIN 1.2 | Point to point | A node address for the |
| LIN 1.3 | (production, | slave node lies in a |
| | development) | range of 0x80 to 0xff. |
| | LIN network | The node address is |
| | (series) | defined by a user or |
| | | applier in a range of |
| | | 0x80 to 0xff. If no |
| | | diagnosis is required, |
| | | and the user of the |
| | | network does not need any |
| | | information on the node |
| | | address, no uniform node |
| | | address is defined for |
| | | each slave node in a |
| | | range of 0x80 to 0xff. |
| LIN 2.0 | Point to point | The node address defined |
| | (production, | by the user is in the |
| | development | range of 0x01 to 0x7e. It |
| | | is also possible to |
| | | define an established |
| | | address for the slave |
| | | node in a range of 0x80 |
| | | to 0xff. |
| | LIN network | The node address is |
| | (series) | defined by the user. If |
| | | no diagnosis is required, |
| | | and the user of the |
| | | network does not need any |
| | | information on the node |
| | | address, the project |
| | | defines a uniform node |
| | | address for each slave |
| | | node in a range of 0x80 |
| | | to 0xff. |
| SAE J2602 | Point to point | In this case, the method |
| | (production, | of node configuration |
| | development) | specified by the user may |
| | | be used, the node address |
| | | is in a range of 0x01 to |
| | | 0x7e. It is also possible |
| | | to define an established |
| | | address for the slave |
| | | node in a range of 0x80 |
| | | to 0xff. |
| | LIN network | In this case, the method |
| | (series) | of node configuration |
| | | specified by the user may |
| | | be used, the node address |
| | | is in a range of 0x01 to |
| | | 0x7e. |

A structure of PCI bytes introduced in Table 3 is shown in Table 5. The abbreviation PCI stands for protocol control information. The protocol control information includes information on the frame type and the transport layer flow control information.

TABLE 5
Structure of the PCI Byte

| | PCI Byte | | | | | | | |
|---|---|---|---|---|---|---|---|---|
| Type | Bit 7 | Bit 6 | Bit 5 | Bit 4 | Bit 3 | Bit 2 | Bit 1 | Bit 0 |

| | | | | | |
|---|---|---|---|---|---|
| SF | 0 | 0 | 0 | 0 | Length |
| | | | | | Number of data bytes used in the |
| | | | | | frame plus 1 for SID or RSID |
| | | | | | (maximum value = 6 − >5 data |
| | | | | | bytes plus SID or RSID; minimum |
| | | | | | value = 1 − >0 data bytes plus |
| | | | | | SID or RSID). |
| FF | 0 | 0 | 0 | 1 | Length/256 |
| | | | | | This is the length of a total |
| | | | | | number of transmittable data |
| | | | | | bytes of the message plus 1 for |
| | | | | | SID or RSID. The four highest- |
| | | | | | value bits of the length of the |
| | | | | | message are transmitted into the |
| | | | | | four lowest-value bits of the |
| | | | | | PCI bytes. |
| CF | 0 | 0 | 1 | 0 | Frame counter |
| | | | | | Counter for CF frames. The first |
| | | | | | CF frame is numbered 1, the |
| | | | | | second is 2, etc. If the message |
| | | | | | has more than 15 CF frames, |
| | | | | | counting of the frame counter is |
| | | | | | continued again using 0, 1, 2, |
| | | | | | . . . |

In case the message does not fit into a single frame, the four highest-value bits of the length of the message are transmitted into the four lowest-value bits of the PCI byte. The eight lowest-value bits of the length of the message are transmitted to the LEN byte introduced in Table 3. The message may include 4095 bytes (length=0xff). In a first example, the following values are produced:

Number of data bytes in the message=700 byte (0x2bc) length=0x2bd, number of data bytes in the message plus 1 LEN=0xbd, eight lowest-value bits of the length PCI=0x12, four lowest-valued bits of PCI include four highest-valued bits of the length, the four highest-valued bits of PCI include the frame type indication.

In a second example, the following values are produced:

Number of data bytes in the message=700 byte (0x2bc) length=0x2bd, number of data bytes in the message plus 1 LEN=0xbd, eight lowest-value bits of the length PCI=0x12, four lowest-valued bits of PCI include four highest-valued bits of the length, the four highest-valued bits of PCI include the frame type indication.

The abbreviation SID in Table 3 stands for service identifier, and determines the request that is to be carried out by the slave node address. Table 6 shows the connection between SID and node address (NAD).

TABLE 6
Correlation between SID and NAD

| NAD | SID | Commentary |
|---|---|---|
| 0x01-0x7e | remains the same | Only for electronic control |
| | for | units (ECU) which use LIN2.0 |
| | ISO 15765-3 | of SAE J2602: It is not |
| | or | possible to use the service |
| | ISO 14229-1 | identifier in a range of |
| | | 0xb0 to 0xb7 for the |
| | | diagnosis, since these |
| | | identities are used for the |
| | | node configuration in the |
| | | LIN standard. |
| 0x80-0xff | project-specific | It is decided by the user |
| | | which type of service is |
| | | used, for instance, UDS, |
| | | proprietary services, ISO, |
| | | etc. |

The required definition of the service and the diagnostic service is usually determined by the project or the user. Some users use ISO services or proprietary services, for example.

It is also possible that the user defines his own communications protocols that are alternative to the LIN protocol, and are certain diagnostic services in this context. According to that, the user has to decide what types of diagnostic services are used.

The abbreviation RSID in Table 3 stands for response service identifier, and determines contents of the response. The RSID for a positive response is typically SID+0x40.

The interpretation of data bytes which are described by the variables D1 to D6 for respectively a datum 1 to datum 6, depends on the service identifier or the response service identifier. If a frame of a protocol is not completely filled, the unused bytes are filled with ones (0xff).

The sequence of the communication depends on a number of requirements. In mass production, for instance, the user specifies the sequence of the diagnostic communication in his system. In production and in the factory the sequence for each specific product is optimized, in order to reduce the duration of manufacturing steps. Accordingly, the sequence is defined especially by the type of project.

Table 7 gives an overview for errors that are able to occur in a communication.

TABLE 7
Communication errors

| Error | Description |
|---|---|
| Negative response | The master receives a negative |
| | response from the slave. |
| Inconsistent content of the | The content of the request or |
| frame. | the response is inconsistent. |
| | This means, for example, that |
| | the received message has a |
| | non-defined PCI or a non- |
| | defined SID or RSID depending |
| | on the project. This error may |
| | be used in addition when the |
| | received user-defined data |
| | bytes (D1 . . . Dx) do not have |
| | the expected values. |
| Error in the sequence | The frame counter of a |
| | sequence of a continuation |
| | frame is inconsistent, e.g. |
| | frame counter = 1 . . . 2 . . . 5 . . . 6. |
| Time out during transmission | The time between the sending |
| | of a request and a positive |
| | response of the slave is |
| | exceeded (t_{RtoutM} > T_{RtoutM}). |
| Communication errors | Communication errors in the |
| | LIN protocol, e.g. interrupted |
| | communication, failed |
| | transfer. |

Depending on the node type, that is, a concrete development of the LIN master or the LIN slave, different error mechanisms have to be implemented. An overview of error treatment, such as may be implemented in the slave nodes, is shown in Table 8.

TABLE 8
Reaction to an error in the slave node
Slave Node

| Error | Reaction |
|---|---|
| Inconsistent content of the | Interruption of receiving, |
| frame. | additional CS frames of the |
| | same receiver are ignored. |
| | Discarding of the of the |
| | transmission. Sending of a |
| | negative response. |
| Error in the sequence | Interruption of receiving, |
| | additional CS frames of the |
| | same receiver are ignored. |
| | Discarding of the data of the |
| | transmission. Sending of a |
| | negative response. |
| Communication errors: | The same reaction as in a |
| | normal communications |
| | operation, is defined by the |
| | user. |

Table 9 shows examples of an error treatment implemented in the master node.

TABLE 9
Reaction to an error in the slave node
Master Node

| Error | Reaction |
|---|---|
| Negative response | Reaction is defined by the |
| | user. |
| Inconsistent content of the | Interruption of receiving, |
| frame. | discarding the data of the |
| | transmission. Sending of a |
| | negative response. |
| Error in the sequence | Interruption of receiving, |
| | discarding the data of the |
| | transmission. Sending of a |
| | negative response. |
| Communication errors | The same reaction as in a |
| | normal communications |
| | operation, is defined by the |
| | user. |

Each project defines the manner of response of the system when an error comes up, and how a transmission current is stopped, for instance, by repeating the transmission, starting again the request or response sequence or by a complete cutoff of the communication.

In one possible development, a diagnostic service according to UDS (Unified Diagnostic Services, a standardized diagnostic service) may be used for road vehicles according to ISO14229-1.2 from the year 2003 for LIN buses and thus LIN protocols. For this, the following Table 10 shows an overview for diagnostic services within the LIN context. However, other services may also be used. Examples of this development are shown in Tables 10 to 13.

Table 10 includes the name of the service and the associated service identifier (SID) which is shown here as a hexadecimal value. Furthermore, a short description is given for each diagnostic service. The columns “Sub-functions” and “SubPosRsp” (suppress positive response message, suppression of a positive response) specify whether sub-functions exist for the respective diagnostic service and whether in each case positive responses are able to be suppressed. In this connection, sub-functions should be distinguished from subparameters. Desired services or functions (e.g. memory size, memory address, etc.) may be specified by sub-parameters, whereas sub-functions call up desired services under a certain sequence scheme, such as a soft reset or a hard, or rather, abrupt reset. The highest-value bit (bit 7) of a parameter of the sub-function or a service parameter byte is used for the suppression of a positive response for the respective service Table 11). As a rule, the RSID, which stands for the response service identifier, is to be formed for positive responses by summation of the response SID having the constant hexadecimal value 0x40. A negative response is used for the RSID 0x7F. In this case the second byte is the SID that has caused an error. The error is described more accurately by a third byte that is a function of the SID.

TABLE 10
Overview on LIN diagnostic services

| | | | | |
|---|---|---|---|---|
| | SID | | | |
| Service name | (hex) | Sub-function | SupPosRsp | Description |

Functional unit for diagnostic and communications management

| | | | | |
|---|---|---|---|---|
| Diagnostic Session | 10 | x | x | Enables diagnostic session |
| Control | | | | |
| ECUReset | 11 | x | x | Slave is requested to carry |
| | | | | out a reset. |
| SecurityAccess | 27 | x | x | Slave is to unlock security |
| | | | | services. |
| ControlDTCSetting | 85 | x | x | Controlled setting values |
| | | | | (DTC, diagnostic trouble |
| | | | | codes) |

Functional unit for data transmission

| | | |
|---|---|---|
| ReadDataByIdentifier | 22 | The master requests the |
| | | reading of a current value of |
| | | a data record as is provided |
| | | by a data identifier. |
| ReadMemoryByAddress | 23 | The master requests reading |
| (Read memory of | | the current value of the |
| address) | | provided memory section. |
| WriteDataByIdentifier | 2E | The master requests writing |
| | | to the data record provided |
| | | by the data identifier. |
| WriteMemoryByAddress | 3D | Request to overwrite the |
| | | provided data section. |

Control over input/output of the functional unit

| | | |
|---|---|---|
| InputOutputControlBy | 2F | Control of input |
| Identifier | | reading/output writing in the |
| | | slave. |

Remote activation of a routine of the functional unit

| | | | | |
|---|---|---|---|---|
| Routine Control | 31 | x | x | Starting, stopping or request |
| | | | | of a result of the routine of |
| | | | | the slave. |

Upload/download of the functional unit (slave)

| | | |
|---|---|---|
| RequestDownload | 34 | Data transmission to the LIN |
| | | slave |
| RequestUpload | 35 | Data transmission from the |
| | | LIN slave |
| TransferData | 36 | Data transmission from the |
| | | LIN slave |
| RequestTransferExit | 37 | Master requests ending data |
| | | transmission. |

Table 11 shows the usual layout of the service parameter byte

TABLE 11
Diagnostic identifier
Service parameter byte (SPB)

| | | | | | | | |
|---|---|---|---|---|---|---|---|
| Bit 7 | Bit 6 | Bit 5 | Bit 4 | Bit 3 | Bit 2 | Bit 1 | Bit 0 |

| | |
|---|---|
| SupPosRsp | Diagnostic session type |

According to this example embodiment, the services mentioned, of the communications protocol provided according to UDS are imaged onto the LIN frame or frames. Such an imaging onto the LIN frames takes place according to the examples described below.

Third example: Start of the standard setting of a diagnostic session.

NAD 0x83, example of a node address,

PCI: 0x02, SID and one data byte, for one single frame

SID 0x10, diagnostic session control service

datum 1: 0x02, programming session specified by UDS

TABLE 12
Diagnostic session control

| Service | LIN ID | LIN data frame |
|---|---|---|
| Diagnostic | 3C | 83 02 10 02 FF FF FF FF |
| session control | | |

Example four: Data transmission to the LIN slave

NAD 0x83, example of a node address,

PCI: 0x10, first frame having more than 6 data bytes

LEN: 0x69, SID and 8 data bytes are to be transmitted

SID: 0x36, transmission data

datum 1: 0x01, block sequence counter (sub-parameter for SID 0x63 according to UDS)

Datum 2-Datum 4 data bytes to be transmitted

NAD 0x83, example of a node address,

PCI: 0x21, continuation frame (CF), second data frame

Datum 2-Datum 4 data bytes to be transmitted

Datum 5-Datum 6 not reserved, set to 0xff.

TABLE 13
Transmission data

| Service | LIN ID | LIN data frame |
|---|---|---|
| Transmission data FF | 3C | 83 10 09 36 01 01 02 03 |
| Transmission data CF | 3C | 83 21 04 05 06 07 FF FF |

In one further development, a proprietary service is able to be imaged into the LIN diagnostic frame. Details on this development are shown in Tables 14 to 17.

TABLE 14
Imaging from proprietary frame to LIN frame

| Proprietary frame | LIN frame |
|---|---|
| | NAD = 0x80 . . . 0xff |

“Request block”

| | |
|---|---|
| “Block length” | Length = “block length − 2 (see |
| | Table 5) |
| “Block title” | SID |
| “Useful information” | Data bytes |
| “Check sum byte” | Last datum of diagnostic session. |
| | (Comment: not the last byte of the |
| | LIN frame, because of slack |
| | bytes.) |

Service request with slave response (request identifier 0x22 . . . 0x60)

| | |
|---|---|
| Request (“block title”) | SID |
| Response (“block title”) | RSID = response (“block title”) − |
| | 0x40 (Comment: Response is request + |
| | 0x80) |

“Block confirmation” (response identifier 0x01)

| | |
|---|---|
| “Block length” | PCI = 02 |
| “Block title” | RSID = SID + 0x40 |
| | RSID = 0x50 (start of diagnostic |
| | session) |
| | RSID = 0x60 (end of diagnostic |
| | session) |
| | RSID = 0x61 (DUT device under test) |
| | device present in test |
| “Check sum” | D1 = “Check sum” |

“No block confirmation” (response identifier 0x02)

| | |
|---|---|
| “Block length” | PCI = 03 |
| “Block title” | RSID = “block title NACK” |
| “Error code” | D1 = “error code” |
| “Check sum” | D2 = “Check sum” |

“Block tester wait” (response identifier 0xFE response without
request)

| | |
|---|---|
| Response (“block title”) | RSID = 0xFE |

Table 15 shows an overview for some diagnostic services within the LIN context. Table 15 includes the names of the services and the associated service identifiers SID (“block title”) which are shown here as hexadecimal values. Furthermore, a short description is given for each diagnostic service.

TABLE 15
Overview of LIN diagnostic services

| | SID | |
|---|---|---|
| | (hex) | Service name |
| Start Diagnostic | 10 | Release of the diagnostic session |
| Session | | |
| End Diagnostic | 20 | Master requests ending data |
| Session | | transmission |
| Read DUT Status | 22 | Master requests the information |
| information Long | | on the state of the slave, of the |
| (Read “device in | | project, of the software or of |
| testing” Long | | the hardware. |
| Read Snapshot 2 Byte | 31 | Master demands the reading of the |
| 16 bit address | | current value of the provided |
| | | memory section. |
| Internal EEPROM | 36 | Slave is to release access to |
| Access Enable | | EEPROM for programming. |
| Flash ROM Access | 38 | Slave is to release access to |
| enable | | flash ROM for programming. |
| Hardware Access | 3a | Slave is to release access to ECU |
| enable | | hardware. |
| Program Flash ROM 16 | 4b | Data transmission to LIN slave |
| bit Area | | for flash programming |
| RAM Access enable | 50 | Release access to RAM |
| Start routine 16 bit | 53 | Execution of the code at a |
| address area | | specified address. |
| “Transparent data | 60 | Using this identification (ID), |
| block with parameter | | project-specific especial |
| transfer” | | commands can be defined. |

The imaging of the services onto the LIN frame may take place according to one of the following examples.

Example five: Beginning of the diagnostic session.

NAD 0x83, example of a node address

PCI: 0x04, SID, 3 data bytes and check sum, single frame

SID: 0x10, Beginning of the diagnostic session.

datum 1: xx, ECU ld byte 1, specified in proprietary protocol

datum 2: xx, ECU ld byte 2, specified in proprietary protocol

datum 3: cs, check sum

Table 16 applies to the start of the diagnostic session.

TABLE 16
Start of diagnostic session

| Service | LIN ID | LIN data frame |
|---|---|---|
| Diagnostic session | 3C | 83 04 10 xx xx cs FF FF |
| control | | |

Example six: Programming of 6 bytes of the flash ROM to address 0x0123.

First frame (FF):

NAD 0x83, example of a node address

PCI: 0x10, first frame having more than 8 data bytes

LEN: 0x0a, SID, 2 address bytes, 6 data bytes and check sum are to be transmitted

SID: 0x4b, “Program flash ROM 16-bit address space”

datum 1: 0x01 MSB of the address, specified in proprietary protocol

datum 2: 0x23 LSB of the address, specified in proprietary protocol

datum 3, datum 4: data byte 1 and data byte 2 continuation frame (CF):

NAD 0x83, example of a node address

PCI: 0x21, continuation frame, second data frame

D1-D4: data bytes to be transmitted (byte 3-byte 6)

D5: cs, check sum

D6: not used, set to 0xFF.

TABLE 17
Data transmission

| Service | LIN ID | LIN data frame |
|---|---|---|
| Transmission data FF | 3C | 83 10 0a 4b 01 23 01 02 |
| Transmission data CF | 3C | 83 21 03 04 05 06 cs FF |

One possible application of the present invention is in the development phase of LIN components, and thus of users of LIN networks and buses, such LIN components being developed in particular as electronic control units (ECU). Consequently, a flashing or a software change of LIN components is possible at the upper cutoff point and within the LIN bus. In addition, the possibility arises of being able to make diagnostic requests in the LIN bus. LIN components, and thus also LIN buses are most wide-spread in the co-called body domain, that is, in vehicle construction, and are used for damper servo motors of ventilation systems, as motors for seat adjustment or for door electronics.

Further advantages and refinements of the present invention are yielded from the description and the accompanying drawing.

It is understood that the aforementioned features and those to be described below may be used not only in the combinations specifically indicated but also in other combinations, or alone, without departing from the scope of the present invention.

The present invention is represented schematically in the figures in light of exemplary embodiments, and is described in detail below with reference to the figures.

### BRIEF DESCRIPTION OF THE DRAWINGS

FIG. 1, in a schematic representation, shows a diagram of a specific embodiment of a sequence of a communication in a LIN network.

FIG. 2, in a schematic representation, shows a diagram of a sequence of a beginning of a diagnostic session.

FIG. 3, in a schematic representation, shows a diagram of a sequence of a first specific embodiment of a diagnostic session.

FIG. 4, in a schematic representation, shows a diagram of a sequence of a first specific embodiment of a diagnostic session.

### DETAILED DESCRIPTION OF EXAMPLE EMBODIMENTS

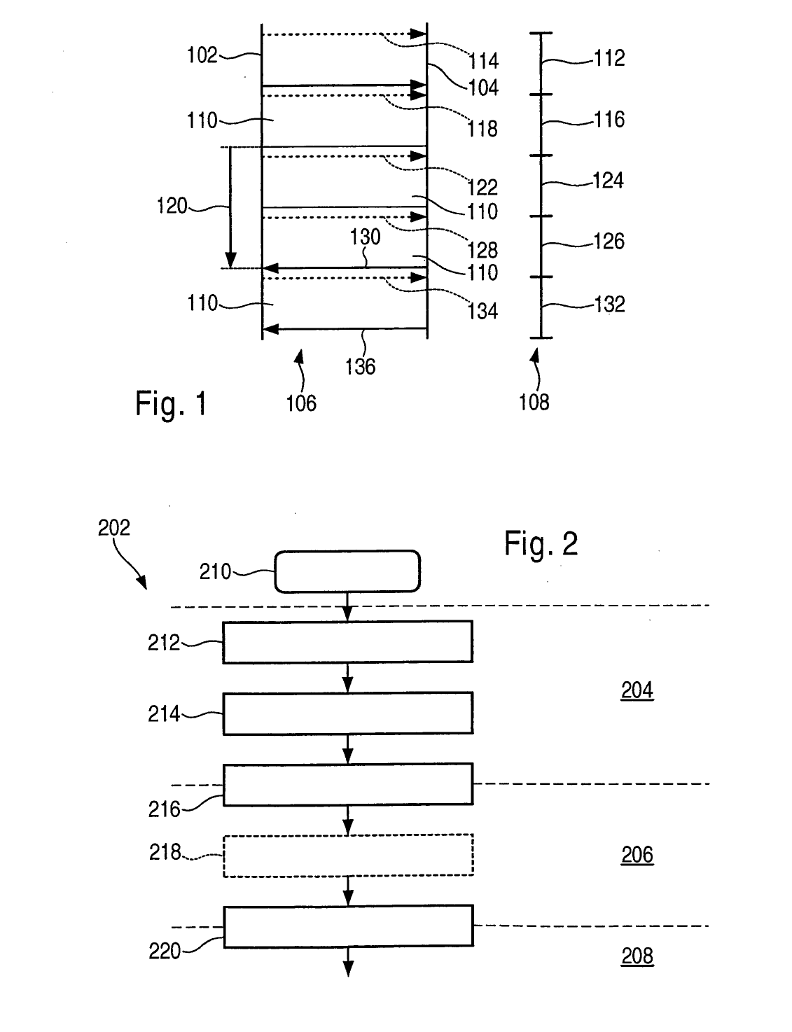

The diagram of FIG. 1 schematically shows a master 102 and a slave 104 of a LIN network 106, which communicate with each other. Within the system developed as the LIN network, master 102 is responsible for time division 108, since slave 104 is only able to send a response after master 102 has sent a header 110 of a frame having ID=0x3d. In a diagnosis of a vehicle having a test device provided as diagnostic master 102, temporal requests that are established by a diagnostic protocol of the user are decided by master 102. In the present specific embodiment, this means that the master cyclically sends 102 messages to slave 102, in order thus to indicate that the subsystem is in a test mode.

The diagnostic communication in LIN network 106 is implemented by two types of communication, namely, by requests of master 102 and responses of slave 104. During a first time segment 112, and thus in a first case, master 102 sends a first request 114 to slave 104, no particular temporal parameters being required. In a second case, during a second time segment 116, during which it is expected by slave 104 that he will send a response to master 102, it is provided that the master sends a second request 118 with header 110 having ID=0x3d, but slave 104 does not respond. In order to ensure an observation of the system, and thus of LIN network 106, a time out (t_{RtoutM}) 120 must be implemented in LIN network 106, after the dispatch of second request 118. Master 102 sends “0x3d”, to which, however, slave 104 does not respond, and master 102 repeats the message with “0x3d” until the time out has expired. An overview on time settings is specified in following Table 18. A third request 122, to which also no response has been made, is dispatched during a third time segment 124. During a fourth time segment 126 master 102 sends a fourth request 128, to which slave 104 reacts with a first response 130, whereupon time out 120 (t_{RtoutM}) is ended. During a fifth time segment 132, master 102 transmits a fifth request 134, to which slave 104 responds using a second response 136.

TABLE 18
Overview of time parameters

| | | Initial | Reset | Maximum |
|---|---|---|---|---|
| Node | Counter | condition | condition | value |
| Master | t_{RtoutM} | Response | Response of | T_{RtoutM} |
| | | to the | the 0x3d | project- |
| | | 0x3d | frame | specific |
| | | frame, as | received by | |
| | | received | the master | |
| | | by the | | |
| | | master | | |

In order to keep the software simple and clear, it is possible to record reset time 120 t_{RtoutM} by counting the 0x3d frames without responses of slave 104. In the case of an observation during the beginning of a communication, it may be necessary to use longer reset times 120 than in the case of normal types of the communication. According to that, the maximum value for a main time (T_{RtoutM}) is dependent, as a rule, on a state of LIN network 106.

FIG. 2 shows a schematic representation of a diagram on the sequence of the beginning of a diagnostic session 202 for an ECU programming of a single slave in a LIN network. In this context, diagnostic session 202 is subdivided into a standard diagnostic session 204, an expanded diagnostic session 206 and a programming 208 of diagnostic session 202.

Diagnostic session 202 for flash-reprogramming 210 begins with reading 212 of an identification of the slave, and in a second step there follows a checking 214 of a state of reprogramming 210.

At the beginning of expanded diagnostic session 206, a first change 216 of the type of diagnostic session is carried out in a third step. In a fourth step, there optionally takes place a suppression 218 of error entries. To terminate expanded diagnostic session 206, a second change 220 takes place in the type of diagnostic session.

The flow of messages given here, between master and slave, is based on the transmission of an erase routine and a write routine for the memory, in this case a flash memory, and on two data blocks. If an interlock of the software is required, the erase routines and the write routines of the flash memory are not stored completely on the electronic control unit (ECU), for security reasons. During the execution of the program sequence, missing parts of these routines are transmitted to the slave. It is provided that two memory blocks having a length of 64 bytes are transmitted to the slave and programmed into the flash memory. The individual steps shown in FIG. 2 are used as the initiation to the flash programming in the LIN network.

The communication in the LIN network takes place during the normal operation using the LIN protocol. For the implementation of special operations, such as the diagnostic session, alternative communications protocols are tunneled through the LIN protocol, in the present specific embodiment. In this instance, there is a switching over of the LIN protocol to such an alternative communications protocol at first change 216, and a shift-in from the alternative communications protocol to the LIN protocol takes place at second change 220, so that expanded diagnostic session 206 for the LIN network takes place using the alternative communications protocol.

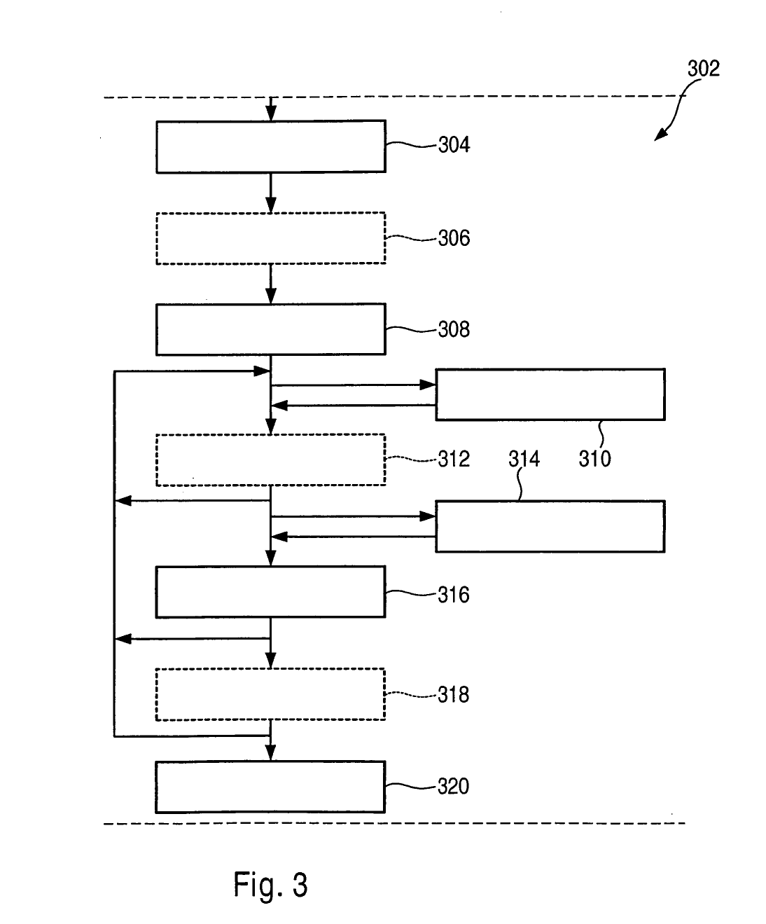

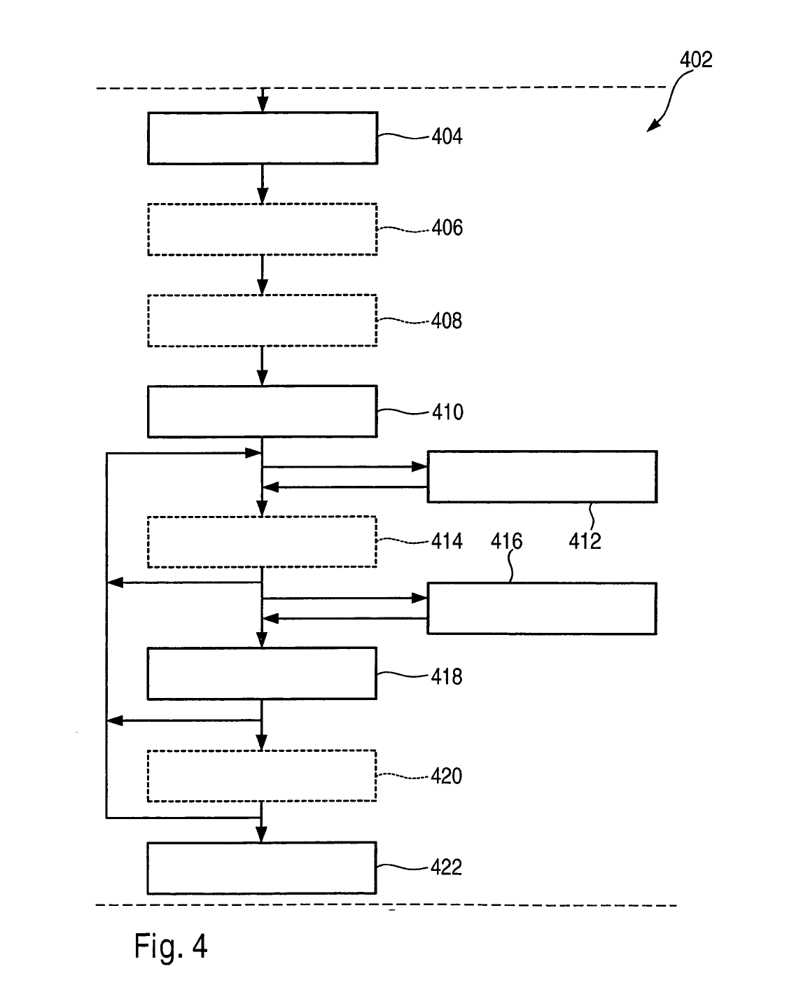

For the implementation of diagnostic session 202 using the other diagnostic protocol, UDS, KWP2000 or proprietary services may be considered as services. When the UDS service is used, the programming of diagnostic session 202 is input only into the so-called “bootloader”. If there is a connection between equivalent users, and thus a point-to-point connection is present, the steps shown in FIG. 2 may in part be left out. In this case, the remaining programming process shown in the diagram in FIG. 3 is sufficient for UDS and the remaining programming process shown in the diagram in FIG. 4 is sufficient for the proprietary service.

The process for flash programming is controlled by sending a sequence of a diagnostic request to the slave. Thereupon the slave transmits a positive or a negative response. In the case of a negative response, an error treatment is required, such an error treatment being project-specific.

FIG. 3 shows a diagram of the sequence of a first specific embodiment of a diagnostic session for the case in which a communications protocol provided as UDS is tunneled through a LIN protocol, in response to programming of an electronic control unit in a LIN network. In this instance, a reprogramming of a slave, which is developed as the electronic control unit (ECU), is undertaken within the LIN network.

For this, a plurality of steps is provided for a programming 302 of the diagnostic session. The start of the programming session takes place in start 304, and in a second step, a security access 306 is granted UDS-specifically, and in a third step a fingerprint 308 is transmitted. After that, in a fourth step, an exchange 310 of an erase routine takes place, whereupon in a fifth step an erasure 312 of a memory is carried out, in this case a flash memory. Steps four and five may be repeated, if necessary. Thereafter, in a sixth step, an exchange 314 of a write routine is undertaken, whereupon in a seventh step writing 316 of the memory takes place; the sixth and the seventh step may also be repeated, if required. A confirmation 318 of the content of the memory is carried out in the eighth step. In the ninth step, the programming of the diagnostic session is ended by a reset 320. It should be pointed out that steps two, four, five, six and eight, in the boxes surrounded by dashed lines in the diagram, are optionally to be carried out in the present specific embodiment. Details on the steps may be seen in the following tables.

The diagnostic data frames of the LIN are thus shown in FIG. 3. This exemplary embodiment is based on flash programming of two data blocks having a length of 64 bytes in the slave. Since no routine for erasure or writing the flash memory is provided in the ECU, such routines are executed in the RAM after transmission to the ECU. In addition, no time statements are provided in this example, such as for awaiting a response, since these depend on the hardware used. Only an order of sequences of the message is described. First of all, a diagnostic programming session is started, as shown in Table 19.

TABLE 19
Start 304 of diagnostic programming session

| Service | LIN ID | LIN data frame |
|---|---|---|
| Diagnostic session | 3C | 83 02 10 02 FF FF FF FF |
| protocol (programming | | |
| session) | | |
| Response SF | 3D | 83 02 50 02 FF FF FF FF |

Thereafter, security access 306 is applied, in case the ECU is using an interlock mechanism. The following Table 20 shows how a test device requests a seed from the component having SID 0x27, that is developed as a LIN slave. The next byte stands for a parameter of a sub-function, which is requesting the seed according to UDS. The response includes an arbitrarily selected seed, for example, 0x21 0x47

TABLE 20
Security access 306, reading the seed (readseed)

| Service | LIN ID | LIN data frame |
|---|---|---|
| Security access | 3C | 83 02 27 01 FF FF FF FF |
| (read-seed) SF | | |
| Response SF | 3D | 83 04 67 01 21 74 FF FF |

As shown in Table 21, security access 306 is continued by transmitting a calculated key that is based on the received seed. A value 0x02 of the sub-function according to UDS specifies the “sendkey” function of service 0x27 for sending the key. If the key, for instance 0x47 0x11, passes a programming access is granted.

TABLE 21
Security access 306, sendkey

| Service | LIN ID | LIN data frame |
|---|---|---|
| Security access | 3C | 83 04 27 02 47 11 FF FF |
| (send-key) SF | | |
| Response SF | 3D | 83 02 67 02 FF FF FF FF |

Since access to the slave is now possible, a software-fingerprint 308 and thus a fingerprint of the software for storage is transmitted into the slave. In this context, the xx and yy bytes are able to be reserved according to the identity of desired fingerprint 308. Thereafter, the data of fingerprint 308 according to UDS, for example 0x01-0x03, are transmitted. Table 22 shows the transmission of fingerprint 308 in exemplary fashion.

TABLE 22
transmission of fingerprint 308

| Service | LIN ID | LIN data frame |
|---|---|---|
| WriteDataByIdentifier | 3C | 83 06 2E xx yy 01 02 03 |
| SF | | |
| Response SF | 3D | 83 03 6E xx yy FF FF FF |

Since, in this example, the slave uses a software interlock, no erase routine is stored in the flash memory. Instead, a programming code for erasing the flash memory is at least partially transmitted directly before carrying out the erase operation, as shown in Table 23.

TABLE 23
Download erase routine

| Service | LIN ID | LIN data frame |
|---|---|---|
| RequestDownload SF | 3C | 83 06 34 00 12 xx yy 0F |
| Response SF | 3D | 83 04 74 20 00 FF FF FF |
| TransferData FF | 3C | 83 10 11 36 01 01 02 03 |
| TransferData CF | 3C | 83 21 04 05 06 07 08 09 |
| TransferData CF | 3C | 83 22 0A 0B 0C 0D 0E 0F |
| Response SF | 3D | 83 02 76 01 FF FF FF FF |
| RequestTransferExit | 3C | 83 1 37 FF FF FF FF FF |
| SF | | |
| Response SF | 3D | 83 01 77 FF FF FF FF FF |

After a complete transmission of the erase procedure, the program code may be checked, as shown in Table 24. Using control sequence (0x31) of the routine, a procedure is started in the slave, having a routine with ID=xxxx, according to UDS, a sub-function 0x01=start being established. Since a certain time period is required for calculating the routine, the response is delayed. However, such a response can be taken into account by a test tool and thus a vehicle test device. In a positive response, routine yyyy is passed along as the result.

TABLE 24
Checking erase routine

| Service | LIN ID | LIN data frame |
|---|---|---|
| RoutineControl SF | 3C | 83 04 31 01 xx xx FF FF |
| Response SF | 3D | no response |
| Response SF | 3D | 83 04 71 01 yy yy FF FF |

Table 25 shows how the flash memory is erased, using the erase routine that was transmitted shortly before. The erase routine is invoked by control sequence 0x31 for this erase routine, and begun with sub-function 0x01=start, according to UDS. An identity (ID) of the erase routine is coded as xxyy. Since erasure 312 takes up a certain time period, some of the RX diagnostic messages of the slave are possibly empty. After the close of the erase procedure, a positive response is sent. The time required for erasure 312 is taken into account by a flash tool.

TABLE 25
Memory erasure

| Service | LIN ID | LIN data frame |
|---|---|---|
| RoutineControl SF | 3C | 83 04 31 01 xx yy FF FF |
| Response SF | 3D | no response |
| Response SF | 3D | no response |
| Response SF | 3D | 83 04 71 01 xx yy FF FF |

In the present example, no write routine to the nonvolatile memory is provided, conditioned upon the interlocking of the software. The following Table 26 shows a message sequence using which the write routine for the slave is downloaded.

TABLE 26
Download write routine

| Service | LIN ID | LIN data frame |
|---|---|---|
| RequestDownload SF | 3C | 83 06 34 00 12 xx yy 0F |
| Response SF | 3D | 83 04 74 20 00 FF FF FF |
| TransferData FF | 3C | 83 10 11 36 01 01 02 03 |
| TransferData CF | 3C | 83 21 04 05 06 07 08 09 |
| TransferData DF | 3C | 83 22 0A 0B 0C 0D 0E 0F |
| Response SF | 3D | 83 02 76 01 FF FF FF FF |
| RequestTransferExit | 3C | 83 01 37 FF FF FF FF FF |
| SF | | |
| Response SF | 3D | 83 01 77 FF FF FF FF FF |

The transmitted bytes are checked for correctness using the command sequences listed in Table 27.

TABLE 27
Checking the write routine

| Service | LIN ID | LIN data frame |
|---|---|---|
| RoutineControl SF | 3C | 83 04 31 01 xx yy FF FF |
| Response SF | 3D | no response |
| Response SF | 3D | no response |
| Response SF | 3D | 83 04 71 01 xx yy FF FF |

Now the currently present first memory block is transmitted, which is shown in Table 28. In a first step, the downloading of 64 (0x40) data bytes at the address xxyy is requested, in this connection. After a positive response, the data are transmitted into the data transfer service (0x36) using successive frames. This data transfer service begins with a request for 66 data bytes (0x42; 64 data, 1 SID and 1 block sequence number byte). Finally, all frames of the transmitted data are dispatched, and a positive response is received. Accordingly, the transmission is able to be closed using a sequence (0x37) for requesting the end of the transmission (RequestTransferExit).

TABLE 28
download first memory block

| Service | LIN ID | LIN data frame |
|---|---|---|
| RequestDownload SF | 3C | 83 06 34 00 12 xx yy 0F |
| Response SF | 3D | 83 04 74 20 00 FF FF FF |
| TransferData FF | 3C | 83 10 42 36 01 01 02 03 |
| TransferData CF | 3C | 83 21 04 05 06 07 08 09 |
| TransferData CF | 3C | 83 22 0A 0B 0C 0D 0E 0F |
| . | . | . |
| . | . | . |
| . | . | . |
| TransferData CF | 3C | 83 2A 3A 3B 3C 3D 3E 3F |
| TransferData CF | 3C | 83 2B 40 FF FF FF FF FF |
| Response SF | 3D | 83 02 76 01 FF FF FF FF |
| RequestTransferExit | 3C | 83 01 37 FF FF FF FF FF |
| SF | | |
| Response SF | 3D | 83 01 77 FF FF FF FF FF |

In subsequent Table 29 it is shown how a second memory block is downloaded. This takes place according to the same scheme as the downloading in Table 28. Such a flash procedure takes a certain time period, which is why an interval should be provided as pause before the downloading of the second data block is able to be started.

TABLE 29
Downloading of the second memory block

| Service | LIN ID | LIN data frame |
|---|---|---|
| RequestDownload SF | 3C | 83 06 34 00 12 xx yy 40 |
| Response SF | 3D | 83 04 74 20 00 FF FF FF |
| TransferData FF | 3C | 83 10 42 36 01 01 02 03 |
| TransferData CF | 3C | 83 21 04 05 06 07 08 09 |
| TransferData CF | 3C | 83 22 0A 0B 0C 0D 0E 0F |
| . | . | . |
| . | . | . |
| . | . | . |
| TransferData CF | 3C | 83 2A 3A 3B 3C 3D 3E 3F |
| TransferData CF | 3C | 83 2B 40 FF FF FF FF FF |
| Response SF | 3D | 83 02 76 01 FF FF FF FF |
| RequestTransferExit | 3C | 83 01 37 FF FF FF FF FF |
| SF | | |
| Response SF | 3D | 83 01 77 FF FF FF FF FF |

After a waiting time provided for the flash procedure, the diagnostic session may be continued. For all the data transmitted and stored in the nonvolatile memory, checking may be activated. Subsequent Table 26 shows a diagnostic sequence suitable for this. According to UDS, a test routine is begun using ID xxyy and sub-function 0x01=start. Such a procedure for checking requires a certain time period, which is why, up until the arrival of a positive or negative response, an interval should be taken into consideration.

TABLE 30
Checking memory blocks

| Service | LIN ID | LIN data frame |
|---|---|---|
| RoutineControl SF | 3C | 83 04 31 01 xx yy FF FF |
| Response SF | 3D | no response |
| Response SF | 3D | 83 04 71 01 xx yy FF FF |

A last step for resetting the ECU is shown in Table 31. In the present example, such a service for resetting is requested using a parameter for a hard, or rather, abrupt resetting (0x01). However, other descriptions of the parameter according to UDS may be provided.

TABLE 31
Resetting the ECU

| Service | LIN ID | LIN data frame |
|---|---|---|
| ECU Reset SF | 3C | 83 02 11 01 FF FF FF FF |
| Response SF | 3D | 83 02 51 01 FF FF FF FF |

FIG. 4 shows a diagram of the sequence of a second specific embodiment of a diagnostic session for the case in which a proprietary communications protocol is tunneled through a LIN protocol, in response to programming of an electronic control unit in a LIN network. In this instance, a reprogramming of a slave, which is developed as the electronic control unit (ECU), is undertaken within the LIN network.

For this, a plurality of steps is provided for a programming 402 of the diagnostic session. Start 404 of the programming session takes place in a first step. In a second step, a flash-ROM access 406 is made available, and in a third step a RAM access 408 is provided. In a fourth step, a fingerprint 410 is transmitted. Thereafter, in a fifth step, there takes place exchange 412 of an erase routine, whereupon in a sixth step, erasure 414 of a memory is carried out. Steps five and six may be repeated, if necessary. Thereafter, in a seventh step, an exchange 416 of a write routine is undertaken, whereupon in an eighth step writing 418 of the memory takes place; the seventh and the eighth step may also be repeated, if required. A confirmation 420 of the content of the memory is carried out in the ninth step. In the tenth step, the programming of the diagnostic session is ended by a resetting 422. It should be pointed out that steps two, three, five, six, seven and nine, in the boxes surrounded by dashed lines, are optionally to be carried out in the present specific embodiment.

The diagnostic data frames of the LIN are thus shown in detail in FIG. 4. This exemplary embodiment is based on flash programming of two data blocks having a length of 64 bytes in the slave. Since no routine for erasure or writing the flash memory is provided in the ECU, such routines are executed in the RAM after transmission to the ECU. In addition, no time statements are provided in this example, such as for awaiting a response, since these depend on the hardware used. Only an order of sequences of the message is described. First of all, a diagnostic programming session is started, as shown in Table 32.

TABLE 32
Start 404 of programming of the diagnostic session

| Service | LIN ID | LIN data frame |
|---|---|---|
| Start Diagnostic Session | 3C | 83 04 10 xx xx cs FF FF |
| SF | | |
| Response SF | 3D | 83 02 50 02 FF FF FF FF |

Thereafter, flash-ROM access 406 is made available (as shown in Table 33).

TABLE 33
Providing flash-ROM access 406

| Service | LIN ID | LIN data frame |
|---|---|---|
| Enable access to flash ROM | 3C | 83 02 38 3b FF FF FF FF |
| Response SF | 3D | 83 02 78 bb FF FF FF FF |

The erase routine and the write routine for the flash memory are loaded into the RAM, RAM access 408 being enabled

TABLE 34
Providing RAM access 408

| Service | LIN ID | LIN data frame |
|---|---|---|
| Enable RAM access | 3C | 83 02 39 3a FF FF FF FF |
| Response SF | 3D | 83 02 79 ba FF FF FF FF |

Since flash-ROM access 406 has now been provided, fingerprint 410 of the software according to Table 35 may be transmitted to the slave. In this context, the xx and yy bytes are reserved according to the identity of desired fingerprint 410. Thereafter, the data of fingerprint 410, such as yy, are transmitted.

TABLE 35
Transmission of fingerprint 410

| Service | LIN ID | LIN data frame |
|---|---|---|
| “Transparent data block | 3C | 83 04 60 xx yy cs FF FF |
| with parameter transfer | | |
| Response SF | 3D | 83 03 A0 xx cs FF FF FF |

Since the slave in this example uses a software interlocking, no routine for erasing is present in the flash memory. Instead, a programming code for erasing the flash memory is at least partially transmitted to RAM address 0x01234, directly before carrying out the erase operation, as shown in Table 36.

TABLE 36
Download erase routine

| Service | LIN ID | LIN data frame |
|---|---|---|
| Write RAM 16 bit FF | 3C | 83 10 13 50 01 23 01 02 |
| Write RAM 16 bit CF | 3C | 83 21 03 04 05 06 07 08 |
| Write RAM 16 bit CF | 3C | 83 22 09 0a 0b 0c 0d 0e |
| Write RAM 16 bit CF | 3C | 83 23 0f cs FF FF FF FF |
| Response SF | 3D | 83 03 90 01 cs FF FF FF |

It is shown in Table 38 below, how the flash memory is erased using the previously transmitted erase routine. The service for the corresponding routine has the designation “bulk-erase flash ROM 16 bit address space”, an associated sub-function 0x00 to the proprietary protocol means that the complete flash memory is erased. Since the erasure takes some time, individual RX diagnostic messages of the slave may be empty. In order to indicate that the LIN slave is still waiting anyway, a response that specifies that the tester is waiting should be transmitted at specific time intervals. After the close of the erase procedure, a positive response is sent. The time required for erasure 414 is taken into account by a flash tool.

TABLE 37
Erasure 414 of the memory

| Service | LIN ID | LIN data frame |
|---|---|---|
| Bulk-erase (main erase) | 3C | 83 03 4d 00 cs FF FF FF |
| flash ROM 16 bit address | | |
| space | | |
| Response SF | 3D | no response |
| Response SF (tester | 3D | 83 02 fe fd FF FF FF FF |
| waiting) | | |
| Response SF | 3D | no response |
| Response SF | 3D | 83 03 8d 01 cs FF FF FF |

In the present example, no write routine to the nonvolatile memory is provided, conditioned upon the interlocking of the software. The following Table 38 shows a message sequence using which a write routine for the slave is downloaded.

TABLE 38
Download write routine

| Service | LIN ID | LIN data frame |
|---|---|---|
| Write RAM 16 bit FF | 3C | 83 10 13 50 02 34 01 02 |
| Write RAM 16 bit CF | 3C | 83 21 03 04 05 06 07 08 |
| Write RAM 16 bit CF | 3C | 83 22 09 0a 0b 0c 0d 0e |
| Write RAM 16 bit CF | 3C | 83 23 0f cs FF FF FF FF |
| Response SF | 3D | 83 03 90 01 cs FF FF FF |

Now the first currently present memory block is transmitted, which is shown in Table 39. The service “reprogram flash ROM 16 bit” starts with a request for 68 data bytes (0x44; 64 data, 1 SID, 2 address bytes (0x0123) and 1 check sum byte). Finally, all frames of the transmitted data are dispatched, and a positive response is received.

TABLE 39
Download first memory block

| Service | LIN ID | LIN data frame |
|---|---|---|
| Program flash ROM 16 bit | 3C | 83 10 44 4b 01 23 01 02 |
| FF | | |
| Program flash ROM 16 bit | 3C | 83 21 03 04 05 06 07 08 |
| CF | | |
| Program flash ROM 16 bit | 3C | 83 22 09 0A 0B 0C 0D 0E |
| CF | | |
| . | . | . |
| . | . | . |
| . | . | . |
| Program flash ROM 16 bit | 3C | 83 2A 39 3A 3B 3C 3D 3E |
| CF | | |
| Program flash ROM 16 bit | 3C | 83 2B 3f 40 cs FF FF FF |
| CF | | |
| Response SF | 3D | 83 03 8b 01 cs FF FF FF |

The following Table 40 begins with downloading a second memory block (address 0x123+40). This also takes place as shown in Table 39. Before downloading of the second memory block is begun, an interval should be introduced, since the flash procedure requires some time.

TABLE 40
Downloading of second memory block

| Service | LIN ID | LIN data frame |
|---|---|---|
| Program flash ROM 16 bit | 3C | 83 10 44 4b 01 63 01 02 |
| FF | | |
| Program flash ROM 16 bit | 3C | 83 21 03 04 05 06 07 08 |
| CF | | |
| Program flash ROM 16 bit | 3C | 83 22 09 0A 0B 0C 0D 0E |
| CF | | |
| . | . | . |
| . | . | . |
| . | . | . |
| Program flash ROM 16 bit | 3C | 83 2A 39 3A 3B 3C 3D 3E |
| CF | | |
| Program flash ROM 16 bit | 3C | 83 2B 3f 40 cs FF FF FF |
| CF | | |
| Response SF | 3D | 83 03 8b 01 cs FF FF FF |

After an interval provided for the flash procedure, the diagnostic session may be continued. For all the data transmitted and stored in the nonvolatile memory, checking may be activated. Subsequent Table 41 shows a diagnostic sequence suitable for this. In the proprietary protocol a check routine having ID xyyx is begun. Such a procedure for checking requires a certain time period, which is why, up until the arrival of a positive or negative response, an interval should be taken into consideration.

TABLE 41
Check memory block

| Service | LIN ID | LIN data frame |
|---|---|---|
| “Transparent data block | 3C | 83 04 60 xy yx cs FF FF |
| with parameter transfer” | | |
| Response SF | 3D | no response |
| Response SF | 3D | no response |
| Response SF | 3D | 83 02 fe fd FF FF FF FF |
| Response SF | 3D | no response |
| Response SF | 3D | 83 03 A0 xx cs FF FF FF |

The last step of resetting the ECU is shown in Table 42. The service “Transparent data block with parameter transfer” is requested using a hard reset (zz) of the parameters (0x01).

TABLE 42
Resetting the ECU

| Service | LIN ID | LIN data frame |
|---|---|---|
| “Transparent data block | 3C | 83 04 06 xx zz cs FF FF |
| with parameter transfer” | | |
| Response SF | 3D | 83 03 A0 yy cs FF FF FF |

1-15. (canceled)

16. A method for operating a LIN bus, whose specifications in normal operation are described by a LIN bus, the method comprising:
tunneling an alternative communications protocol through the LIN protocol for carrying out a special operation.

17. The method as recited in claim 16, wherein a service connected with the alternative communications protocol is imaged on a frame of the LIN protocol.

18. The method as recited in claim 17, wherein at least one datum of the frame is reserved as a function of the service.

19. The method as recited in claim 18, wherein at least one datum of the diagnostic frame is reserved as a function of the service.

20. The method as recited in claim 16, wherein at least one user of the LIN bus is programmed via the alternative communications protocol.

21. The method as recited in claim 16, wherein, during the special operation, a diagnosis is carried out, the alternative communications protocol being imaged on a diagnostic frame of the LIN protocol.

22. The method as recited in claim 17, wherein the alternative communications protocol is a UDS protocol, the UDS protocol being tunneled through the LIN protocol, a UDS service being imaged on the frame.

23. The method as recited in claim 17, wherein the alternative communications protocol is a proprietary protocol, the proprietary protocol being tunneled through the LIN protocol, a proprietary service being imaged on the frame.

24. The method as recited in claim 17, wherein the alternative communications protocol is a KWP2000 protocol, the KWP2000 protocol being tunneled through the LIN protocol, a KWP2000 service being imaged on the frame.

25. The method as recited in claim 17, wherein parameters of the alternative communications protocol are reserved as a function of the service.

26. A system, comprising:
a LIN bus that has a plurality of users and whose specifications in normal operation are described by a LIN protocol, at least one of the users adapted to tunnel an alternative communications protocol through the LIN protocol to carry out a special operation.

27. The system as recited in claim 26, wherein a first one of the users is a master and at least one second one of the users is a slave.

28. The system as recited in claim 27, wherein, for carrying out a communication, the master is adapted to transmit requests to the slave and the slave is adapted to transmit responses to the master.

29. A memory device storing a computer program, the computer program, when executed by a processor, causing the processor to perform the steps of tunneling an alternative communications protocol through a LIN protocol on a LIN bus.

30. The memory device as recited in claim 29, wherein a special operation is carried out as a result of the tunneling.
